(19) United States
(12) Patent Application Publication
(10) Pub. No.: US 2026/0275776 A1
(43) Pub. Date: Sep. 17, 2026

(54) MOTOR VEHICLE LOCK

(71) Applicant: Kiekert Aktiengesellschaft, Heiligenhaus (DE)

(72) Inventors: Madhu BASAVARAJAPPA, Leverkusen (DE); Tobias KLOCKE, Mettmann (DE)

(73) Assignee: Kiekert Aktiengesellschaft, Heiligenhaus (DE)

(21) Appl. No.: 19/163,140

(22) PCT Filed: Jan. 29, 2024
(86) PCT No.: PCT/DE2024/100075

§ 371 Date: Sep. 8, 2025

(30) Foreign Application Priority Data
Mar. 15, 2023 (DE) 10 2023 106 526.2

(51) Int. Cl. E05B 79/08

(52) U.S. Cl. CPC E05B 79/08

(57) ABSTRACT

A motor vehicle lock includes a locking mechanism having a rotary latch and at least one pawl, wherein the rotary latch can be latched in at least one latching position by means of the pawl, and having an actuating lever which is received pivotably in a bearing point wherein the actuating lever has arms for retaining the actuating lever in the bearing point, and wherein the retaining arms of the actuating element fit over the bearing point after being inserted into the bearing point and wherein the retaining arms are deformable.

The invention relates to a motor vehicle lock comprising a locking mechanism having a rotary latch and at least one pawl, wherein the rotary latch can be latched in at least one latching position by means of the pawl, and having an actuating element which is received pivotably in a bearing point, wherein the bearing point has arms for retaining the actuating element in the bearing point, and wherein the lever arms of the actuating element fit over the bearing point after being inserted into the bearing point.

Levers are often used in motor vehicle locks to implement the various functions of the motor vehicle lock. In addition to the locking mechanism, the motor vehicle lock then has, for example, a lever mechanism that enables locking, child safety, anti-theft protection, closing of the locking mechanism, opening of the side door, and/or electrical unlocking of the locking mechanism, to name just a few examples of the functions in a motor vehicle lock. The lever mechanisms are actuated here by means of a rod, a Bowden cable, and/or, for example, by means of an electric motor with a downstream gearing. Depending upon their arrangement in the motor vehicle and functionality, the actuating elements or levers are mounted either in a lock case or in the lock housing or on a lever itself.

Merely by way of example, reference is made to DE 10 2008 039 240 A1, which discloses a locking device having at least one locking mechanism with a rotary latch and a pivotable first pawl, wherein a release lever is moved such that the release lever during its movement interacts with a driving pin of the first pawl and forms a lateral pawl spring of a contact between the driving pin and the release lever during the interaction. If, for example, the pawl is considered an actuating element in the motor vehicle lock, the pawl is mounted on a metal bearing mandrel, wherein the bearing mandrel is fastened in the lock case by deforming and preferably by riveting.

If, on the other hand, one considers DE 10 2018 116 313A 1 , this document discloses a fastening mechanism in which a pivoting component, in this case a mass inertia element, is held on a plastic mandrel by means of a bayonet-like closure. For an assembly of the mass inertia element, the plastic pin is passed with its arms through recesses of the mass inertia element, and then the mass inertia element undergoes a rotation, wherein the rotation of the mass inertia element in relation to the plastic pin is designed in such a way that the mass inertia element can move freely without the arms coming into alignment with the recesses, so that reliable functioning and retention of the mass inertia element can be realized. The plastic mandrel serves here as a bearing point for the mass inertia element and, after insertion of the mass inertia element, forms a secure support for the mass inertia element, wherein the arms of the plastic mandrel fit over the mass inertia element.

The receptacles known from the prior art for mounting an actuating element in the motor vehicle lock have proven themselves in principle. However, there is always an effort to realize bearing points for actuating elements in motor vehicle locks with the least possible means in order to, for example, save upon components, reduce the required installation space, or reduce the weight of the motor vehicle lock. In any case, however, it must be possible to ensure that the functionality be able to be actuated safely, since motor vehicle locks are safety-relevant components. Based upon these prerequisites, the invention is aimed at improving the motor vehicle lock.

The object of the invention is to provide an improved motor vehicle lock. Furthermore, it is an object of the invention to provide a bearing point for an actuating element, which bearing point uses the smallest possible number of components, is space-saving, and has the lowest possible weight. In addition, a structurally simple and cost-effective way of realizing the bearing point shall be possible.

According to the invention, the object is achieved by the features of independent claim 1. Advantageous embodiments of the invention are specified in the dependent claims. It should be noted that the exemplary embodiments described below are not limiting; rather, any possible variations of the features described in the description, the dependent claims, and the drawings are possible.

According to claim 1, the object of the invention is achieved in that a motor vehicle lock is provided, comprising a locking mechanism having a rotary latch and at least one pawl, wherein the rotary latch can be latched in at least one latching position by means of the pawl, and having an actuating element which is received pivotably in a bearing point, wherein the bearing point has arms for retaining the actuating element in the bearing point, and wherein the retaining arms of the actuating element fit over the bearing point after being inserted into the bearing point, and wherein the lever arms are deformable. The inventive design of the bearing point now makes it possible to provide a bearing point for an actuating element, which bearing point enables the actuating element to be held securely with minimal component outlay. On the one hand, the deformation process can ensure secure retention, and, on the other, the deformation of the actuating element itself can permit a bearing point, i.e., a pivoting mounting of the actuating element. In addition to secure retention, forming a connection between the bearing element and the actuating element can provide a pivot bearing, which is created solely by the interaction between the bearing point and the actuating element. Thus, a pivotable mounting of an actuating element in the motor vehicle lock can be provided with the least possible means, i.e., with the smallest possible number of components. The forming itself replaces the alternative methods for connecting or creating a bearing point. The bearing point itself is provided by the interaction of the actuating element and the bearing point. A separate axle or rivet, for example, can be dispensed with.

In a lock for a motor vehicle, which is also called a locking system, locking mechanisms are installed which consist of a rotary latch and at least one locking pawl. The locking mechanism in the lock interacts with a lock holder that is either attached to the body of the motor vehicle or to the door, flap, sliding door, etc. The relative movement between the lock holder and the rotary latch causes the rotary latch to be pivoted, and, at the same time, the locking pawl comes into engagement with the rotary latch. There are locking mechanisms with pre-latch and main latch which are widely known from the prior art.

Depending upon the embodiment, there are one- or two-stage locking mechanisms, which then have a pre-latch and/or a main latch. The locking pawl is preferably brought into engagement with the rotary latch by spring-loading. A release lever is used to unlock, i.e., to release, the locking pawl from the rotary latch. The release lever acts upon the locking pawl in such a way that the locking pawl disengages from the rotary latch, and the rotary latch can move from the latching position into an open position. The rotary latch is mostly moved by means of a spring element and/or due to a tensile load resulting from the lock holder in combination with the door seal.

An actuating lever chain with at least one actuating lever is used to actuate the release lever. The actuating lever can, for example, be an internal actuating lever or an external actuating lever, to name examples of areas of application for an actuating lever. With the help of the actuating lever, the release lever is moved and the locking mechanism is unlocked.

It can be advantageous if two, three, or more retaining arms fit over the actuating lever or the actuating element. On the one hand, the number of retaining arms can be used to adjust the pivoting movement of the actuating element or the actuating lever, and on the other, the number of retaining arms can be used to influence the freedom of play of the actuating element in the bearing point. The retaining arms therefore serve, on the one hand, to adjust the pivot angle and, on the other, to enable stabilization of the bearing for the actuating lever. Depending upon the functionality, which can be adjusted using the actuating lever in the motor vehicle lock, the number of retaining arms can be selected or used accordingly.

If the bearing point and the actuating element are made of a metal sheet, this again results in an advantageous design variant. The provision of the bearing point and the actuating element made of metal makes it possible, on the one hand, to use cost-effective components and, on the other, to permit a stable bearing for the transmission of greater forces as well. Greater forces are required, for example, where a vehicle lock needs to be closed. Large forces may also be required when opening a door element that is frozen, for example. Here, the metal components of the articulated connection of the metal parts can be used advantageously. Consequently, not only can a cost-effective, articulated connection with a small number of components be provided, but it is also possible to transport or transmit large forces across the bearing point. Deformation can be carried out using the simplest structural means, e.g., with a stamp, which in turn requires the lowest possible manufacturing effort.

In a further embodiment variant of the invention, the bearing point is formed from an opening having an identical diameter. The bearing point is provided with an opening into which the actuating element is inserted. After the retaining arms have been deformed, the actuating element is connected to the bearing point. If a substantially circular opening is stamped or drilled into the bearing point, for example, this results in cost-effective and simple production. In addition to the cost-effective production of the opening, pivoting of the actuating element can be easily achieved by using an opening with a uniform diameter.

In a further embodiment variant of the invention, the bearing point has at least one deformation, in particular a fold or an impression. If a deformation is introduced into the bearing point itself, the bearing point can take on an additional function. The bearing point serves, as the name suggests, to accommodate and bear the actuating element. If, for example, a fold is formed into the bearing point, the bearing point can also serve as a stop means in the interaction between the actuating element and the bearing point. The fold can then interact with, for example, the actuating element and/or a retaining arm and thus constitute a pivoting limit for the actuating lever. In other words, the actuating lever can then be moved against the fold when pivoting, so that a separate stop for the actuating lever is not necessary. This reduces the number of components required to provide a bearing point for a pivotably mounted lever to a minimum. However, it is also conceivable for an impression to additionally or alternatively be formed into the bearing point. An impression in the bearing point can, for example, also be easily formed into the bearing point, during manufacture of the bearing point, using a forming stamp. The impression then protrudes unilaterally beyond the bearing point and, depending upon the arrangement of the impression, can serve as a stop for the actuating lever or as a stop for a retaining arm. It is of course also conceivable that preferably two, even more preferably three or more, impressions be arranged on the circumference of the opening of the bearing point. It is also conceivable, for example, that each retaining arm be assigned an impression, so that a stable contact of the actuating element is possible, which can be advantageous, for example, when transmitting large forces. Folds and impressions can be present together in the bearing point and interact with the retaining arms and/or an extension of the actuating lever itself.

If the bearing point has a separation point in the region of the opening, a variant of the invention can in turn be provided. A separation point means that the bearing point has a separation all around the opening. The separation of the bearing point in the region of the opening can advantageously interact with a fold on the circumference of the opening, so that on the one hand the fold, and on the other the separation point can serve as a stop limit for the movement of the actuating element. This advantageous embodiment variant allows a bearing point to be provided for the limited mobility of the actuating element without the need for additional parts to limit the pivoting. Advantageously, of course, folds, impressions, and separation points can work together to enable secure retention and/or limitation of the actuating element.

If the bearing point has a tab, wherein the tab extends at least partially into the opening of the bearing point, so that securing the position of the actuating element can be provided, then, again, an advantageous embodiment of the invention can be achieved. An extension can serve as a tab, and extends from a border of the opening on the tab towards the center of the opening. The opening is thus limited. The tab can also be molded into the tab during the manufacturing of the opening and serves as a support for the actuating element. Advantageously, the tab has a symmetrical design and extends beyond a center point of the opening. By creating an additional tab that covers the opening, the actuating element can be further stabilized in the bearing point. The tab thus serves to secure the position to enable the actuating element to be guided as precisely as possible in the bearing point.

The deformation, in particular the fold and/or impression and/or the separation point and/or the tab, can form a stop for the actuating element. The tab can thus be assigned a dual function, in particular if the tab not only serves to secure the position of the actuating element, but also interacts with the actuating element in such a way that the tab constitutes a pivoting limit for the actuating element. Depending upon the arrangement and design of the lever mechanism according to the invention, the modifications mentioned at the bearing point can be incorporated together into the bearing point and/or the actuating element, so that the corresponding functionalities can be achieved with the bearing point. Different pivot angles can be set by arranging the stops at appropriate distances, and it can be ensured that the actuating element be held securely in the bearing point, so that a force can be transmitted across the bearing point with as little play as possible.

A variant of the invention can also result from the fact that the bearing point itself is designed as part of a pivotably mounted lever. The bearing point itself can constitute a lever and be mounted pivotably. This makes it possible either to exceed a large lever travel or to provide a complex mechanism in the motor vehicle lock. A large movement is necessary, for example, if the door element is to be opened, or if the locking mechanism is to be pulled from a pre-latching position of the locking mechanism to a main latching position of the locking mechanism by means of the actuating element according to the invention.

In order to enable the retaining arms to be deformed and the actuating element to be mounted in the bearing point with as little play as possible, it can be advantageous if the bearing point has a greater material thickness than the actuating element. As illustrated in detail in the exemplary embodiment, the material differences allow for a degree of play to be set between the bearing point and the actuating element, so that precise movements can also be realized using the bearing point in the lock.

The invention is explained in more detail below with reference to the accompanying drawings on the basis of a preferred exemplary embodiment. However, the principle applies that the exemplary embodiments do not limit the invention, but are merely advantageous embodiments. The features depicted can be implemented individually or in combination with further features of the description as well as the claims—individually or in combination.

### IN THE FIGURES

FIG. 1 is an exemplary representation of the invention of an axisless joint in a three-dimensional representation, wherein the bearing point is formed by a pivotably mounted lever,

FIG. 2 shows an alternative embodiment of the axisless joint from an opposite view with respect to FIG. 1,

FIG. 3 shows a first step for joining the axisless joint or before joining the bearing point with the actuating element,

FIG. 4 shows a joined joint as a section through the bearing point, and

FIG. 5 also shows a view of the bearing point in a section with a view of the formed actuating element.

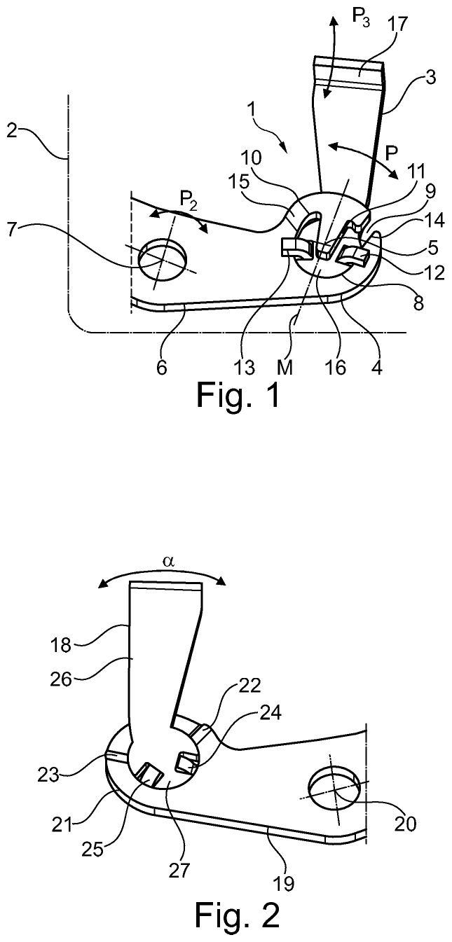

In FIG. 1, a three-dimensional view of an axisless joint 1 as part of a motor vehicle lock 2 is shown. The axisless joint 1 comprises an actuating lever 3 and a bearing point 4. The actuating lever 3, which can, for example, be a closing lever for a closing device, is pivotably mounted in the bearing point 5 in the direction of the arrow P around the axis 5. In this exemplary embodiment, the bearing point 4 is designed as part of a pivotably mounted lever 6. The lever 6 is mounted in the motor vehicle lock 2 so as to be pivotable about the axis 7. The lever 6 and thus the bearing point 4 can therefore also be pivoted around the axis 7 in the direction of the arrow P2.

The bearing point 4 comprises an opening 8, wherein the opening 8 is enclosed by the bearing point 4. A parting line 9 is formed in the bearing point 4, wherein the parting line 9 forms part of a fold 10 in this exemplary embodiment. In addition, a tab 11 is formed into the fold 10, which tab serves to stabilize the actuating lever 3 or the actuating element 3.

The actuating lever 3 is fastened to the bearing point 4, wherein the actuating lever 3 is form-fittingly connected to the bearing point 4 by means of lever arms. The actuating lever 3 is consequently pivotally mounted around the axis 5 and is held in the opening 8 by means of the retaining arms 12, 13. As can be clearly seen in the exemplary embodiment, the movement of the actuating element 3 is limited on the one hand by the parting line 9 and the stop face 14 formed on the parting line 9 and the stop face 15 on the fold 10. The actuating lever 3 is consequently accommodated in the bearing point 4 so as to be movable back and forth in the direction of the arrow P, starting from the stop face 15 up to the stop face 14.

The position of the actuating lever 3 is secured by the interaction of the circular end 16 of the actuating lever 3 in interaction with the retaining arms 12, 13 and securing the position by the tab 11. As can be clearly seen, the tab 11 extends over the center of the axis 5, so that a secure mounting of the actuating lever 3 in the bearing point 4 is possible. In this exemplary embodiment, the tab 11 is formed symmetrically with respect to the central axis M of the tab 11.

In this exemplary embodiment, the pivot angle about the axis 5 of the actuating element 3 is limited by the stop faces 14, 15, wherein it is also conceivable for the retaining arms 12, 13 in interaction with the fold 10 and the parting line 9 to serve as stops for the actuating lever 3.

The actuating lever 3 can, for example, serve as a closing lever for a locking mechanism. For this purpose, a part of a rotary latch (not shown) could engage in the fold 17 and move the rotary latch from a pre-latching position into a main latching position. In order to enable a movement of the actuating lever 3 in the direction of the arrow P3, the lever 6 would be driven, for example, by means of a motor and/or a Bowden cable and pivoted about the axis 7, so that a closing force could be exerted on the rotary latch. In order to ensure a secure engagement between the actuating lever 3 and the rotary latch, the actuating lever 3 can be pivoted around the axisless joint 1 in the direction of the arrow P during the closing process.

FIG. 2 shows an alternative embodiment of an actuating element 18 in a three-dimensional representation and in a rear view of the actuating lever 18 with respect to FIG. 1. The actuating lever 18 is also mounted in a pivotable lever 19, wherein the lever 19 is pivotable about the axis 20. In this exemplary embodiment, the bearing point 21 is provided with impressions 22, 23. The impressions 22, 23 are introduced into the bearing point 21 in different directions. If the impression 22 forms an elevation in the bearing point 21, the impression 23 is formed as a depression in the bearing point 21. The impressions or deformations 22, 23 are thus formed in different directions with respect to the bearing point. Again, two retaining arms 24, 25 can be seen, which secure the actuating lever 18 in the bearing point 21. If the elevation 22 serves as a stop face for the actuating lever 18, the recess 23 can, for example, interact with the retaining arm 25 so that stops are provided for the actuating lever 18. Depending upon the design of the impressions 22, 23, the arrangement of the retaining arms 24, 25, and the orientation of the extensions 26 of the actuating lever 18, as well as the arrangement of the extension 26 with respect to the circular end 27 of the actuating lever 18, the pivot angle a of the actuating lever 18 can be adjustable. Of course, combinations of the features shown can also be provided, such that different functions can be realized with the axisless joint 1. In the two variants of FIGS. 1 and 2, the actuating lever 3, 18 is configured identically, whereas the bearing points 4, 21 form different receptacles for the actuating lever 3, 18.

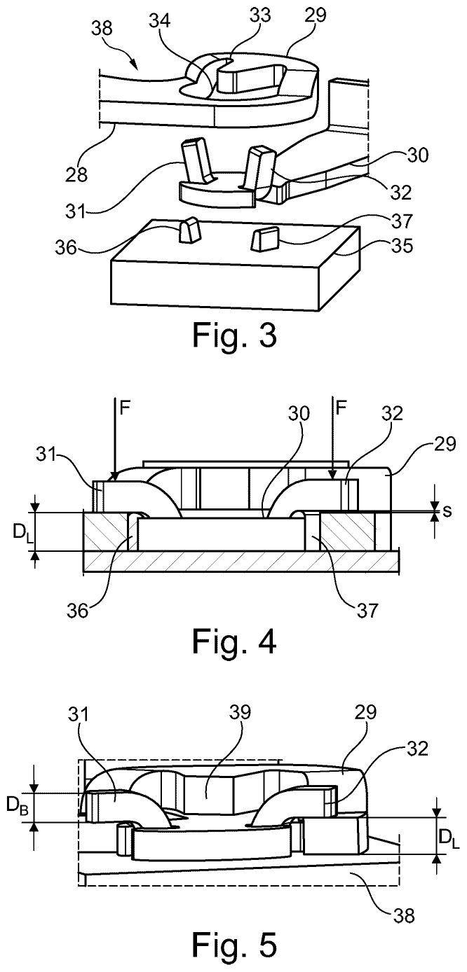

FIG. 3 shows the arrangement of a lever 28 with a further embodiment variant of a bearing point 29 before assembly with an actuating lever 30. In this respect, it can be seen in FIG. 3 that the retaining arms 31, 32 are reproduced in an undeformed state. However, it can also be seen that a fold 33 is formed into the bearing point 29 and extends circumferentially around the opening 34 in some regions. In addition, FIG. 3 shows an assembly aid which has supports 36, 37 for deforming the retaining arms 31, 32. FIG. 3 shows the state of the axisless joint 38 before the joining of the actuating lever in the bearing point 29 or the lever 28.

FIG. 4 now shows the joined state of the actuating lever 30 and bearing point 29. The retaining arms have been formed using, for example, a stamp with a force F, with the fold supports 36, 37 serving as counterbearings. The supports 36, 37 are formed higher in the assembly aid 35 than the material thickness DI of the bearing point 29, so that a clearance S is established between the arms 31, 32 and the bearing point 29. By means of the assembly aid 35 and in particular by means of the fold supports 36, 37, a precise alignment between the bearing point 29 and the retaining arms 31, 32 can be set.

FIG. 5 shows the joining of the actuating lever 30 to the bearing point 29 with an alternative assembly aid 38. The assembly aid 38 dispenses with the supports 36, 37, so that, when the retaining arms 31, 32 are deformed, a play-free resting of the retaining arms 31, 32 on the bearing point 29 can be achieved. For this purpose, the bearing point 29 has a larger material thickness Di than the actuating lever 30. The material thickness DB of the actuating lever 30 is less than the material thickness DL of the bearing point 29.

In any case, the inventive design of an axisless joint allows for a structurally simple, secure mounting of an actuating lever in a motor vehicle lock, which can be achieved with the smallest possible number of components. Depending upon the clearance S to be set in combination with a tab 39, precise guides of the actuating lever can also be realized, so that even large forces can be transmitted safely by means of the actuating lever.

### LIST OF REFERENCE SIGNS

1, 38 axisless joint
2 motor vehicle lock
3, 18, 30 actuating element
4, 21, 29 bearing point
5, 7, 20 axis
6, 19, 28 lever
8, 34 opening
9 parting line
10 fold
11,39 tab
12, 13, 24, 25, 31, 32 retaining arm
14, 15 stop face
16, 27 circular end
17, 33 fold
22, 23 impressions
26 extension
35, 38 assembly aid
36, 37 support
P, P2, P3 arrow
M central axis
a pivot angle
F force
S arrow
D_{L}, D_{B} material thickness

1. A motor vehicle lock that comprises a locking mechanism having a rotary latch and at least one pawl, wherein the rotary latch can be latched in at least one latching position by means of the pawl, and having an actuating lever which is received pivotably in a bearing point wherein the bearing point has arms for retaining the actuating lever in the bearing point, and wherein the retaining arms of the actuating element over the bearing point after being inserted into the bearing point, wherein the retaining arms are deformable.

2. The motor vehicle lock according to claim 1, wherein two, three, or more retaining arms fit over the actuating element.

3. The motor vehicle lock according to claim 1, wherein the bearing point and the actuating element are formed from a metal sheet.

4. The motor vehicle lock according to claim 1, wherein the bearing point is formed from an opening having an identical diameter.

5. The motor vehicle lock according to claim 1, wherein the bearing point has at least one deformation, in particular a fold and/or an impression.

6. The motor vehicle lock according to claim 4, wherein the bearing point has a separation point in the region of the openings.

7. The motor vehicle lock according to claim 4, wherein the bearing point has a tab, wherein the tab extends at least partially into the opening of the bearing point, so that a bearing lock for the actuating element can be provided.

8. The motor vehicle lock according to claim 2, wherein the deformation, in particular the fold and/or impression and/or the separation point and/or the tab, forms a stop for the actuating element.

9. The motor vehicle lock according to claim 1, wherein the bearing point is formed as part of a pivotably mounted lever,

10. The motor vehicle lock according to claim 1, wherein the bearing point has a greater material thickness than the actuating element.
